(19) United States
(12) Patent Application Publication
(10) Pub. No.: US 2012/0250606 A1
(43) Pub. Date: Oct. 4, 2012

(54) ENABLING SIMULTANEOUS TRANSMISSIONS IN WIRELESS NETWORK

(75) Inventors: Wen Gao, West Windsor, NJ (US); Jianling Li, Brooklyn, NY (US)

(73) Assignee: THOMSON LICENSING, Issy Les Moulineaux (FR)

(21) Appl. No.: 13/517,359

(22) PCT Filed: Dec. 21, 2009
(86) PCT No.: PCT/US09/06685

§ 371 Date: Jun. 20, 2012

(51) Int. Cl. H04B 7/14; H04W 4/00

(52) U.S. Cl. 370/315; 370/328

(57) ABSTRACT

A method for enabling simultaneous data transmissions in a wireless network includes broadcasting a first signal from a first node, receiving the first signal by a second node, and transmitting a second signal derived from the first signal by the second node. The second signal is received by the first node. A third signal is transmitted from a third node to the first node simultaneous with transmitting the second signal. The first node receives a combination signal which includes the second signal and the third signal. The first node then decodes the third signal from the combination signal using the first signal.

### TECHNICAL FIELD

The invention generally relates to wireless communication networks, and more particularly for enabling simultaneous transmissions in such networks.

### BACKGROUND OF THE INVENTION

A wireless local area network (WLAN) provides a wireless connection of two or more nodes through an access point (AP). As schematically illustrated in FIG. 1, a WLAN 100 includes two nodes N2 110 and N1 120, an access point (AP) 130 and a relay node 140. Transmission in the WLAN 100 is performed in two directions: uplink, i.e., a node sends data to the access point 130 or downlink, i.e., the access point 130 broadcasts data to all nodes in the network 100. In general, a source node is a transmitting node and a destination node is a desired receiving node. Any one node can act as a source or destination if transmitting or receiving respectively.

In the exemplary WLAN 100 the nodes 110 and 120 are hidden nodes to each other. That is, both nodes 110 and 120 can receive data sent from the access point 130, but one node (e.g., node 110) cannot receive data transmitted by the other node (e.g., node 120), thus nodes 110 and 120 can be considered to be interference free to each other. The WLAN 100 further includes a relay node 140 associated with the access point 130. The relay node 140 is assumed to have good communication channels available to both nodes 110 and 120. Thus, the relay node 140 can receive and transmit data to and from the nodes 110 and 120.

The wireless transmission of data in a WLAN is defined in the various IEEE 802.11 standards, which require separating uplink and downlink transmissions into different time slots. Thus, these standards do not allow simultaneous transmissions in both directions. For example, during the transmission opportunity (TXOP) of the access point 130, it broadcasts (in a downlink direction) data to the node 110. Here, a TXOP is defined as a message exchange opportunity between a transmitter and a designated receiver. A TXOP can include not only the transmission by an access point 130, but also an expected response from a designated receiver. The data transmitted by the access point 130 is also received at a relay node (RN) 140 and a node 120. Then, during the TXOP of a node 110, data frames are sent, in the uplink direction, by the node 110 to the access point 130. As nodes 110 and 120 are hidden nodes to each other, the uplink data from node 110 cannot be received at the node 120. The scheduling approach of separating uplink and downlink transmissions, as is known in the art, limits at least the throughput of the WLAN 100, because during a TXOP of a given node, a communication with the access point can be only in either the uplink direction or downlink direction, but not both.

Therefore, it would be an advantageous to provide a solution that would reduce the limitations discussed above.

### SUMMARY OF THE INVENTION

Certain embodiments of the invention include a method for enabling simultaneous data transmissions in a wireless network. The method includes broadcasting a first signal from a first node, receiving the first signal by a second node, transmitting by the second node a second signal derived from the first signal. The second signal is received by the first node. A third signal is transmitted from a third node to the first node simultaneous with transmitting the second signal. The first node receives a combination signal comprising the second signal and the third signal. The first node then decodes the third signal from the combination signal using the first signal.

Certain embodiments of the invention include further include a first network device. The network device includes a transmitter for broadcasting a first signal, wherein the data is broadcasted during a transmission opportunity (TXOP) of the first network device, a receiver for receiving a combination signal during the TXOP of the first network device, where the combination signal includes a second signal and a third signal, where the second signal derived from the first signal and transmitted by a second network device, and the third signal is transmitted by a third network device. The first network device includes a processor for decoding the third signal from the combination signal using the first signal.

Certain embodiments of the invention also include a method for simultaneous data transmissions in a wireless network. The method includes broadcasting a first signal during a transmission opportunity (TXOP) of a first network device, receiving a combination signal during the TXOP of the first network device, where the combination signal comprising a second signal and a third signal, and where the second signal is derived from the first signal and is transmitted by a second network device, and the third signal is transmitted by a third network device. Decoding of the third signal from the combination signal is performed by the first network device using the first signal.

### BRIEF DESCRIPTION OF THE DRAWINGS

The subject matter that is regarded as the invention is particularly pointed out and distinctly claimed in the claims at the conclusion of the specification.

The foregoing and other features and advantages of the invention will be apparent from the following detailed description taken in conjunction with the accompanying drawings.

FIG. 1 is a diagram illustrating an exemplary WLAN;

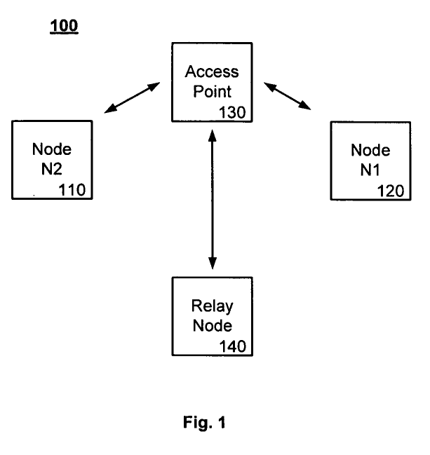

FIGS. 2a and 2b are diagrams illustrating the WLAN operating according to aspects of the invention;

FIG. 2c illustrates the sequential operations of nodes in the WLAN operating according to aspects of the invention;

FIG. 3 is a flowchart describing an example method for conducting simultaneous data transmissions according to one embodiment of the invention; and

FIG. 4 is a block diagram of a network device constructed according to aspects of the invention.

### DETAILED DESCRIPTION OF THE INVENTION

It is important to note that the embodiments disclosed by the invention are only examples of the many advantageous uses of the innovative teachings herein.

In accordance with the principles of the invention a method for simultaneous data transmissions from multiple nodes in a WLAN is provided. This is achieved by utilizing the property that the two hidden nodes are interference free to each other and that the access point has the knowledge of data being transmitted by a relay node. By allowing simultaneous transmissions between multiple nodes in the uplink and downlink directions, the system throughput is increased.

In accordance with one embodiment, a system is formed by employing a cooperative relay, the hidden node property, and analog network coding. In accordance with certain principles of the invention a virtual downlink transmission (VDT) is defined as a transmission in the downlink direction, accomplished by cooperation between an access point 130 and one relay node 140. A virtual uplink transmission (VUT) is a transmission in the uplink direction achieved by cooperation between a source node (e.g., node 110) and a relay node 140 through the analog network coding. A regular rate transmission (RRT) is the transmission of data between two nodes, e.g., node 110 and the access point 130 at a data rate that is within the capacity of the channel between node 110 and the access point 130.

A high rate transmission (HRT) is defined as the transmission of data between two nodes, e.g., node 120 and the access point 130 at a data rate that exceeds the capacity of the channel between the two nodes, node 120 and the access point 130, but within the capacity of the cooperative relay system. The cooperative relay system includes, for example, the node 120, the access point 130, and the relay node 140. In such a case, the destination node (e.g., node 120) cannot decode the received data based on its reception from only the access point 130, because the destination node 120 requires that additional data be received from the relay node 140.

Analog network coding is the operation of decoding a signal based on prior information. For example, when two nodes transmit signals simultaneously, the packets may collide. However, the signal resulting from a collision is usually the sum of the two colliding signals after incurring attenuation, phase, and time shifts. Therefore, if the receiver node knows the content of the packet that interfered with the signal it wants, the receiver node can cancel the signal corresponding to that known signal.

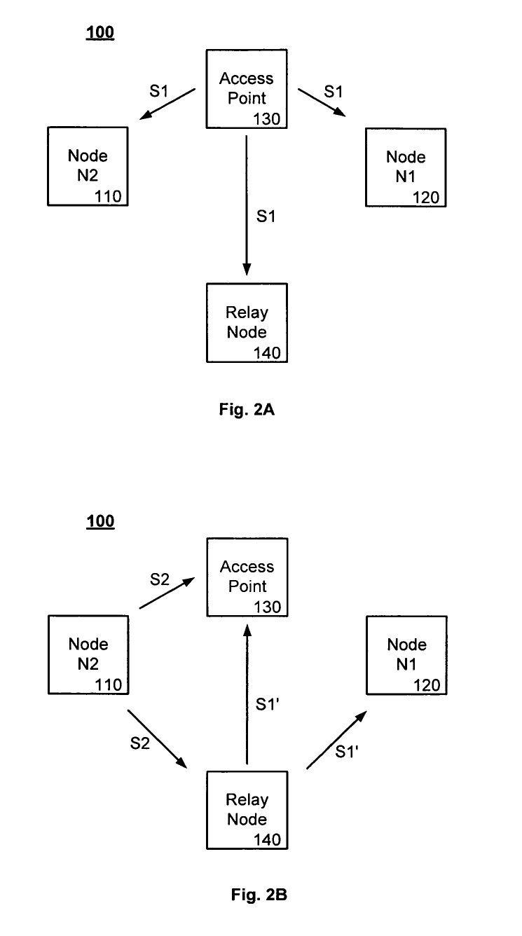

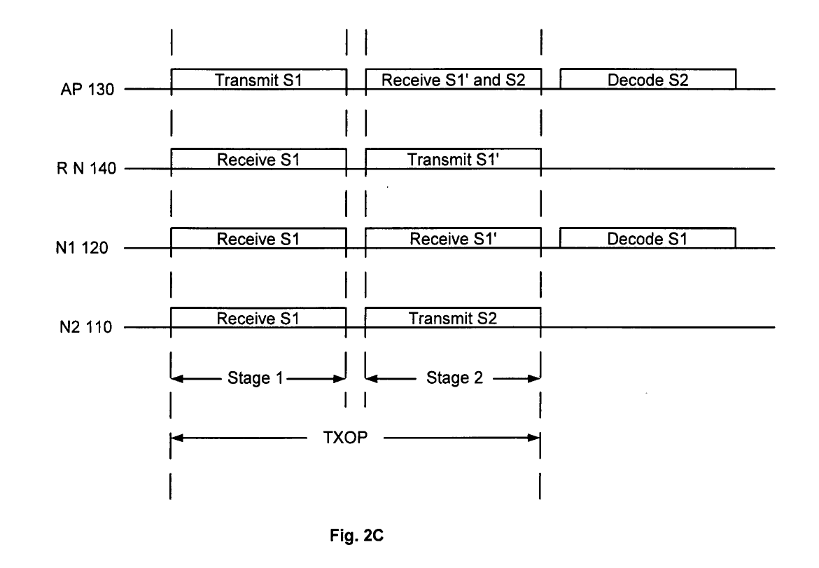

The method for simultaneous transmission disclosed herein is performed in two stages. FIG. 2A represents a first of a two part stage of message exchanges. In the first stage, the access point (AP) 130 is the broadcast transmitter, and Node N1 120 and relay node (RN) 140, on the receiver side, form a cooperative relay system. The access point 130 broadcasts data (signal S1) in downlink to node N1 120 and relay node 140 using high rate transmissions (HRT) so that node N1 120 is not able to decode based on its reception.

FIG. 2B depicts a second stage of the method. In the second stage, the relay node 140 amplifies and forwards the earlier received signal S1. This amplified and forwarded signal is designated as S1′. The signal S1′ is transmitted to N1 120 using high rate transmission (HRT) so that N1 120 is able to decode based on its receptions in the two stages. The two stages altogether forms a virtual downlink transmission (VDT) for N1 120. The relay node 140 can use all kinds of cooperative relaying schemes. In one embodiment, an amplify-and-forward (A&F) cooperative relaying scheme is utilized.

It should be noted that in the second stage, the access point 130 is available to perform other tasks, such as receiving the signals from node N2 110, e.g., signal S2. In addition, the access point 130 also receives the message S1′ transmitted by the relay node 140. Thus, multiple simultaneous transmissions are received at the access point 130. The access point 130 can decode the message S2 from the mixed signal of S1′ and S2, because the access point 130 already knows the contents of the signal S1′. FIG. 2B also indicates that relay node 140 may receive the signal S2. But, since relay node 140 is transmitting S1′, and the signal S2 is addressed to the access point 130, then, the signal S2 at relay node 140 is ignored. Likewise, any possible reception of S1′ by node 110 is also ignored.

FIG. 2C illustrates a timeline representing operations of the nodes in a wireless network system 100 in the two stages. In Stage 1, the access point (AP) 130 generates a high rate broadcast transmission of signal S1. Nodes N1 120 and N2 110 as well as the relay node (RN) 140 receive the high rate broadcast transmission signal S1. In stage 2, the relay node 140 performs its programmed function to transmit S1′ to node N1 120 so that node N1 can finally decode S1. But, at the same time, node N2 110 transmits regular rate signal S2 to the access point 130 according to a schedule previously set up to allow both the relay node 140 and the node N2 110 to transmit simultaneously. Thus, the access point 130 receives both messages S1′ and S2 on the same channel at the same time. Normally, such a simultaneous collision of two different messages from two differ nodes would be undecodable by the access point 130. However, according to aspects of the invention, since the access point 130 previously transmitted message S1 and also knows its amplified and forwarded signal S1′, then the access point 130 can receive the two transmissions S1′ and S2 simultaneously and can decode the signal S2 using the teachings presented below.

In another aspect of the invention, both downlink and uplink data are transmitted in the same TXOP time interval. In the example of FIG. 2C, the replay node 140 transmits high rate signal S1′ to node N1 120. The original signal S1 was a downlink transmission. Thus, S1′ represents a continued distribution (retransmission) of downlink information to node N1 120. In the same Stage 2 time interval, node N2 110 sends an uplink transmission of signal S2 to the access point 130 at a regular uplink rate. This apparent collision of signal S1′ and S2 at the access point 130 is purposefully scheduled by the access point 130. Before the TXOP time interval shown in FIG. 2C, the access point 130 established a communication time and transmitted that timeline in a message to be used each of the nodes in the network of FIGS. 2A and 2B. Thus, the access point 130 purposefully schedules an uplink transmission and a downlink transmission in the same TXOP time interval. As an additional aspect of the specific example of FIGS. 2A-2C, the uplink (S2) transmission from node N2 110 to the access point 130 is a regular rate transmission, and the downlink (S1′) transmission from relay node 140 is a high rate transmission.

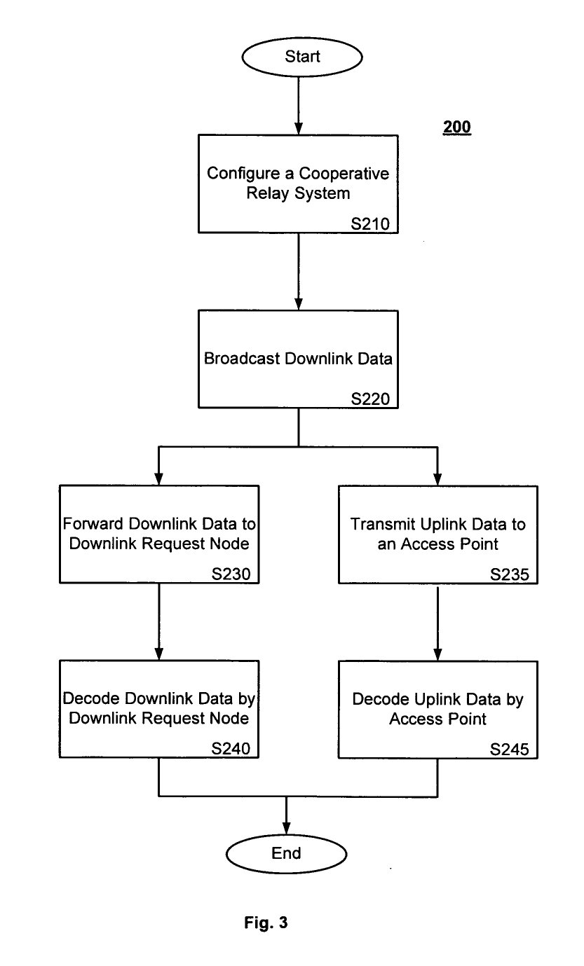

FIG. 3 shows a non-limiting and exemplary flowchart 200 describing the method for simultaneous data transmissions of nodes to an access point in both downlink and uplink directions as implemented according to one embodiment of the invention. The method will be described with a reference to the wireless network 100 depicted in the FIG. 2 representations.

In an embodiment of the invention, the method of simultaneous transmissions can be divided into two stages. Both stages are performed within the transmission opportunity (TXOP) time interval of a node in the network. Without limiting the scope of the invention the method will be described with a reference to a specific embodiment where simultaneous transmissions are performed during the TXOP time interval of the access point 130.

At step S210 a cooperative relay system is configured. The cooperative relay system includes, for example, the node N1 120, the access point 130, and the relay node 140. Node N1 120 requires reception of both a downlink signal S1 and a downlink signal S1′ to decode information in signal S1. The relay node 140 accommodates this need by amplifying a received downlink signal S1 and transmitting it as signal S1′. Another node, N2 110, can transmit an uplink signal S2 to the access point 130. The access point 130 allows an efficient utilization of bandwidth by permitting the simultaneous transmission of uplink signal S2 and downlink signal S1′. The access point 130 accommodates this simultaneous transmission by configuring and scheduling the activities of the cooperative relay system before the broadcast of the S1 signal.

At step S220, during the transmission opportunity (TXOP) of the access point 130, the access point 130 broadcasts data via signal S1 in the downlink direction using a HRT. That is, the data cannot be decoded by the node 120 upon its reception. It should be noted that data transmitted in the downlink direction is also received by the relay node 140 and node 110.

In the second stage, at step S230, the relay node 140 forwards the received downlink data to node 120 using the high rate transmission via signal S1′, thereby enabling the node 120 to decode information based on data received at step S220 and step S230. The relay node 140 can use any cooperative relaying technique in transmitting data to the node 120. Such techniques include, but are not limited to, amplify-and-forward, decode-and-forward, and the like. For example, when utilizing the amplify-and-forward technique, the signal (r₁) received at the node 120 after the completion of step S230 may be represented as follows:

$${r}_{1} = [ \begin{matrix}{H}_{1 , AP} \\ {H}_{1 , RN} {WH}_{RN , AP}\end{matrix} ] {s}_{1} + [ \begin{matrix}{I}_{{N}_{1}} & {0}_{{N}_{1} \times {N}_{RN}} & {0}_{{N}_{1}} \\ {0}_{{N}_{1}} & {H}_{1 , RN} W & {I}_{{N}_{1}}\end{matrix} ] [ \begin{matrix}{N}_{1 , AP} \\ {N}_{RN , AP} \\ {N}_{1 , RN}\end{matrix} ] \qquad ( 1 )$$

where N_{AP}, N₁, N₂, N_{RN} are defined as the number of antennas at the access point 130, node 120, node 110 and the relay node 140; H_{j,i} ∈ C^{N}^{ₙ}^{×N}^{ᵢ} is the channel matrix of channel from Nodeᵢ to Nodeⱼ, (i, j can be any node including the access point); N_{j,i} ∈ C^{N}^{ⱼ}^{×1} is the noise vector; W ∈ C^{N}^{_{RN}}^{N}^{_{R}} is the gain matrix at the relay node 140; I_{N}_{ᵢ} is an identity matrix of rank Nᵢ; 0_{N}_{ⱼ}_{×N}_{ᵢ} ∈ C^{N}^{ⱼ}^{×N}^{ᵢ}; 0_{N}_{ᵢ} ∈ C^{N}^{ⱼ}^{×N}^{ᵢ} are all-zero matrices and C denotes the set of complex numbers.

In one example, Node₁, Node₂, Node_{AP}, and Node_{RN} can respectively represent the node 120, node 110, access point 130, and relay node 140.

The signal r₁ is a vector of 2N₁ entries. The first N₁ entries correspond to the signal received by the node 120 at S220. The second N₁ entries correspond to the signal received by the node 120 at S230.

At step S240, the node 120 decodes the received data signal r₁ using any decoding technique for wireless signals. The decoding technique may be, but is not limited to, minimum mean-squared error (MMSE), zero-forcing, and the like.

At step S235, which occurs concurrently with step S230 during the second stage in the TXOP of the access point 130, the node 110 sends data to the access point 130 in the uplink direction using the regular rate transmission via signal S2. Nodes 110 and 120 are hidden nodes to each other, thus there is no interference at node 120 due to this transmission. Thus, signals S1′ and S2 are received by the access point 130 simultaneously via steps S230 and S235 respectively.

At step S245, the uplink data (S2) is decoded by the access point 130. To accommodate the decoding at step S245, the access point 130 utilizes prior knowledge of the downlink data, channel state information (CSI) of the channel from access point 130 to the relay node 140, the channel from relay node 140 to access point 130, and the channel from node 110 to access point 130 as well as the gain matrix at relay node 140. In accordance with an exemplary embodiment, the received signal (r_{AP}) at the access point 130 can be represented as follows:

$${r}_{AP} = {H}_{AP , RN} {WH}_{RN , AP} {s}_{1} + {H}_{AP , 2} {s}_{2} + [ \begin{matrix}{H}_{AP , RN} W & {I}_{{N}_{AP}}\end{matrix} ] [ \begin{matrix}{N}_{RN , AP} \\ {N}_{AP , RN}\end{matrix} ] \qquad ( 2 )$$

By subtracting the known signals S₁ (sent by the access point 130 at step S220) from the signal r_{AP}, given known values of the channel matrices H_{AP,RN} and H_{RN,AP}, and a known value of the gain matrix W, the equivalent signal (Z_{AP}) derived from the received signal (r_{AP}) can be represented as follows:

$${z}_{AP} = {r}_{AP} - {H}_{AP , RN} {WH}_{RN , AP} {s}_{1} = {H}_{AP , 2} {s}_{2} + [ \begin{matrix}{H}_{AP , RN} W & {I}_{{N}_{AP}}\end{matrix} ] [ \begin{matrix}{N}_{RN , AP} \\ {N}_{AP , RN}\end{matrix} ] \qquad ( 3 )$$

The signal Z_{AP} is based on the uplink data (signal S2) to the access point sent by the node 110. The matrixes H_{j,i} ∈ C^{N}^{_{RN}}^{×N}_{RN}, 1, and N_{j,i} ∈C^{N}^{ⱼ}^{×1} are as defined above. The CSI of channels can be estimated using training sequences. The access point 130 can decode the signal Z_{AP} using any known decoding techniques including, for example, MMSE, zero-forcing, and the like. It should be emphasized that steps S230, S235, S240 and S245 are performed during a TXOP of a single node, thereby allowing simultaneous uplink and downlink transmissions.

It will be appreciated by those skilled in the art that the teachings disclosed herein can be advantageously applied to a WLAN including a plurality of access points, many pairs of hidden nodes, and more than one relay node. The relay node 140 can be either a dedicated relay node or a regular node acting as a relay node. Furthermore, the teachings of the present invention can be advantageously in current versions or new versions of the IEEE 802.11 WLAN standards.

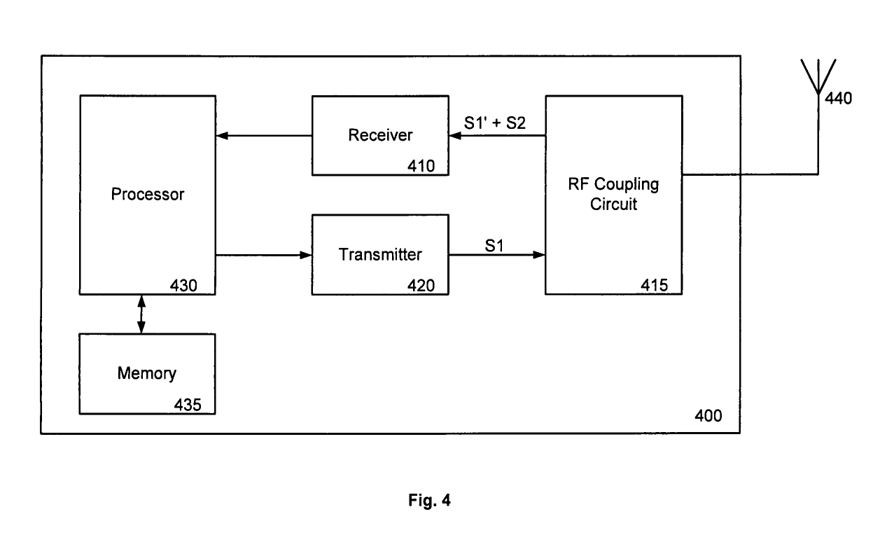

FIG. 4 shows an exemplary block diagram of a network device 400 constructed in accordance with an embodiment of the invention. The network device 400 typically includes a transmitter and modulator 420 and a receiver and demodulator 410 coupled via an RF circuit 415 to one or more antennas 440. A processor 430 is coupled to memory 435 to access both program and data information. The processor 430 is coupled to the transmitter 420 to transfer data to be transmitted. The processor 430 is coupled to the receiver 410 to input demodulated data for decoding. The transmitter 420 broadcasts data (S1) in a downlink direction using a high rate transmission. The data is transmitted during the TXOP of the network device 400. The receiver 410, during the same TXOP, receives data transmitted in an uplink direction simultaneously from relay node 140 and node N2 110 as signals S1′ and S2 respectively. (See FIG. 2B). The processor 430 decodes the new uplink data (S2) from a mixed signal (S1′ and S2) based on a prior knowledge of the broadcasted data (S1). In accordance with an embodiment of the invention the network device 400 is an access point.

The foregoing detailed description has set forth a few of the many forms that the invention can take. It is intended that the foregoing detailed description be understood as an illustration of selected forms that the invention can take and not as a limitation to the definition of the invention. It is only the claims, including all equivalents that are intended to define the scope of this invention.

Most preferably, the principles of the invention are implemented as any combination of hardware, firmware and software. Moreover, the software is preferably implemented as one or more application programs tangibly embodied on one or more program storage units or computer readable medium devices. One of ordinary skilled in the art would recognize that a “machine readable medium” is a medium capable of storing data and can be in a form of a storage device, a digital circuit, an analog circuit, or combination thereof. The application program may be uploaded to, and executed by, a machine comprising any suitable architecture. Preferably, the machine is implemented on a computer platform or processor having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

1. A method for simultaneous data transmissions in a wireless network, the method comprising:
broadcasting a first signal from a first node;
receiving the first signal by a second node;
transmitting a second signal derived from the first signal, by the second node, wherein the second signal is received by the first node;
transmitting a third signal from a third node to the first node simultaneous with transmitting the second signal, wherein the first node receives a combination signal comprising the second signal and the third signal; and
decoding, at the first node, the third signal from the combination signal using the first signal.

2. The method of claim 1, wherein broadcasting comprises a broadcast transmission from an access point.

3. The method of claim 1, wherein receiving the first signal by a second node comprises receiving the first signal by a relay node.

4. The method of claim 1, wherein transmitting a second signal derived from the first signal comprises transmitting the second signal by a relay node that receives the first signal and then amplifies and forwards the first signal as the second signal.

5. The method of claim 1, further comprising:
receiving the first signal by a fourth node;
receiving the second signal by the fourth node;
decoding, by the fourth node, the first signal using information of the received first signal and the received second signal.

6. The method of claim 5, wherein the third node and the fourth node are hidden nodes to each other.

7. The method of claim 1, further comprising the step of:
scheduling, by the first node, a simultaneous transmission of the second signal and the third signal by the second node and third node respectively, before the step of broadcasting.

8. A first network device, comprising:
a transmitter for broadcasting a first signal, wherein the data is broadcasted during a transmission opportunity (TXOP) of the first network device;
a receiver for receiving a combination signal during the TXOP of the first network device, the combination signal comprising a second signal and a third signal, the second signal derived from the first signal and transmitted by a second network device, the third signal transmitted by a third network device; and
a processor for decoding the third signal from the combination signal using the first signal.

9. The first network device of claim 8, wherein the decoding is performed using an analog network decoding.

10. The first network device of claim 8, wherein the first network device is an access point.

11. The first network device of claim 10, wherein the second network device is a relay node.

12. A computer readable medium having stored thereon instructions which, when executed by a computer, perform a method comprising:
scheduling two simultaneous transmissions of two different signals from two different nodes;
broadcasting a first signal from a first node;
receiving the first signal by a second node;
transmitting a second signal derived from the first signal, by the second node, wherein the second signal is received by the first node;
transmitting a third signal from a third node to the first node simultaneous with transmitting the second signal, wherein the first node receives a combination signal comprising the second signal and the third signal;
decoding, at the first node, the third signal from the combination signal using the first signal.

13. A method performed by a first device in a wireless network, the method comprising:
broadcasting a first signal;
receiving a combination signal, the combination signal comprising a second signal and a third signal received concurrently, the second signal derived from the first signal and transmitted by a second device in the wireless network, the third signal transmitted by a third device in the wireless network; and
decoding the third signal from the combination signal using the first signal.

14. The method of claim 13, wherein the decoding is performed using an analog network decoding.

15. The method of claim 13, wherein:
the step of broadcasting comprises broadcasting the first signal from an access point,
the step of receiving a combination signal comprises receiving the combination signal at the access point, wherein the second signal is received from a transmission of a relay node in the wireless network, and the third signal is received from a transmission of a separate node in the wireless network.
